(19) United States
(12) Patent Application Publication
(10) Pub. No.: US 2016/0110303 A1
(43) Pub. Date: Apr. 21, 2016

(54) ELECTRONIC DEVICE AND SYSTEM FOR SHARING THE EDID OF A DISPLAY AMONG MULTIPLE HOSTS

(71) Applicant: ASIX ELECTRONICS CORPORATION, HSINCHU (TW)

(72) Inventors: CHENG-CHUNG WEI, HSINCHU CITY (TW); TSUNG MING SHEN, HSINCHU COUNTY (TW); YUNG-CHI CHUNG, HSINCHU CITY (TW)

(21) Appl. No.: 14/516,025

(22) Filed: Oct. 16, 2014

(51) Int. Cl. G06F 13/28; G06F 13/42

(52) U.S. Cl. CPC G06F 13/28; G06F 13/4221

(57) ABSTRACT

The present disclosure provides an electronic device that comprises a memory and a controller. The memory includes a first memory location and a second memory location, which are configured to store data in an alternate manner The controller is configured to write, when connection of a display to the electronic device is detected, extended display identification data (EDID) of the display through a first channel to one of the first and second memory locations, and to enable the EDID of the display to be accessible to hosts through second channels.

### TECHNICAL FIELD

The present invention relates to an electronic device and system for sharing extended display identification data (EDID) of a display among multiple hosts.

### BACKGROUND

With the fast development in multimedia technology and the increasing demand for controlling multiple computers, a user is allowed and may need to control several hosts through at least one monitor. To achieve this purpose, KVM (keyboard, video and mouse) technology or dedicated video/audio sharing equipment is generally employed. As far as monitor is concerned, information on the type, parameters and characteristics of a monitor is disclosed in extended display identification data (EDID). In some existing approaches, the EDID of a monitor is stored in an electrically-erasable PROM (EEPROM). In general, in a multi-host system the number of EEPROMs equals the number of hosts. As a result, for the purpose of multi-host sharing, a plurality of EEPROMs corresponding to the multiple hosts may be required. Such approaches are not considered cost effective for a relatively large amount of EEPROMs used.

### SUMMARY

The present disclosure provides an electronic device to alleviate the above-mentioned issues. In an embodiment according to the present disclosure, a memory is configured to dynamically store EDID of a display. For example, a first memory location and a second memory location of the memory are used to store EDID of a display in an alternate manner, and a third memory location of the memory is used to store a default EDID. Moreover, a controller includes a master control unit corresponding to a display, and several slave control units each corresponding to one of multiple hosts. Furthermore, each of the first control unit and second control units has an individual channel for transmission of EDID.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

Embodiments, or examples, of the disclosure illustrated in the drawings are now described using specific languages. It will nevertheless be understood that no limitation of the scope of the disclosure is thereby intended. Any alterations and modifications in the described embodiments, and any further applications of principles described in this document are contemplated as would normally occur to one of ordinary skill in the art to which the disclosure relates. Reference numbers may be repeated throughout the embodiments, but this does not necessarily require that feature(s) of one embodiment apply to another embodiment, even if they share the same reference number.

It will be understood that when an element is referred to as being “connected to” or “coupled to” another element, it may be directly connected to or coupled to the other element, or intervening elements may be present.

The objectives and advantages of the present invention are illustrated with the following description and upon reference to the accompanying drawings, in which:

FIG. 1 is a block diagram of a system in accordance with some embodiments of the present invention.

FIG. 2 is a schematic diagram showing a structure of a memory in accordance with some embodiments of the present invention.

FIGS. 3A and 3B are schematic diagrams showing a method of detecting the connection status of a display in accordance with some embodiments of the present invention.

FIG. 4 is a flow diagram of a method of sharing the extended display identification data (EDID) of a display among multiple hosts in accordance with some embodiments of the present invention.

FIG. 5 is a block diagram of a system in accordance with some embodiments of the present invention.

FIG. 6 is a flow diagram of a method of sharing the EDID of displays among multiple hosts in accordance with some embodiments of the present invention.

### DETAILED DESCRIPTION

The embodiments of the present invention are shown in the following description with the drawings, wherein similar or same components are indicated by similar reference numbers.

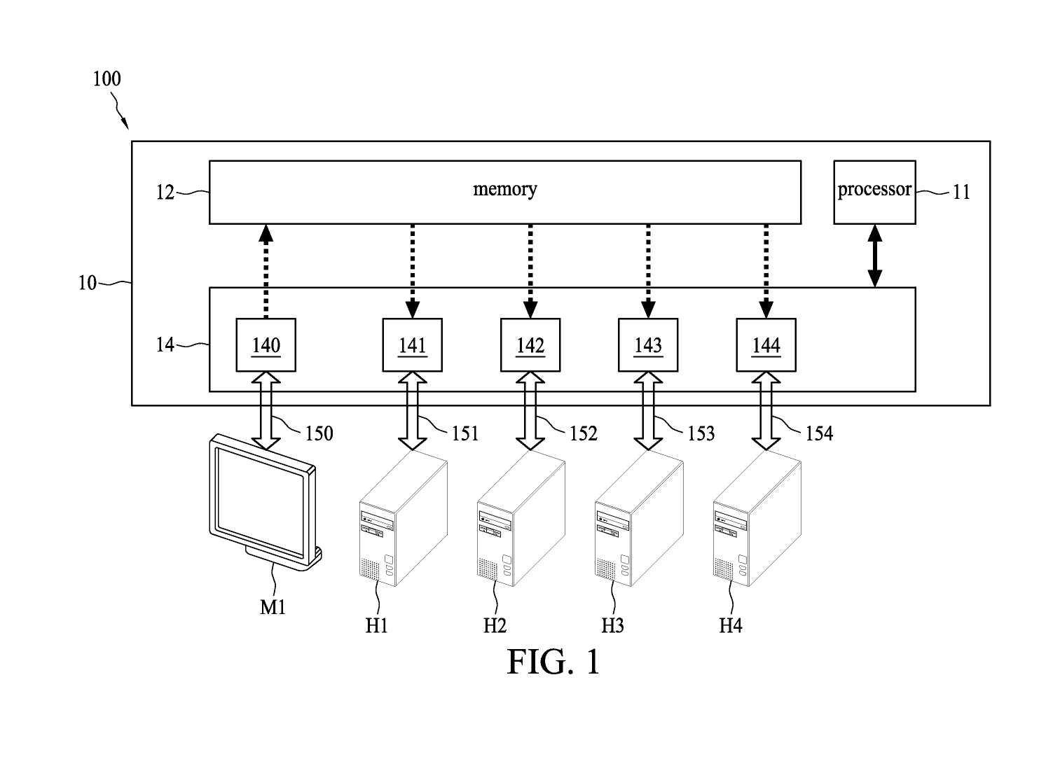

FIG. 1 is a block diagram of a system 100 in accordance with some embodiments of the present invention. Referring to FIG. 1, the system 100 includes a display M1, hosts H1-H4, and an electronic device 10 capable of sharing the extended display identification data (EDID) of the display M1 among the hosts H1-H4.

The display M1, for example, a monitor, liquid crystal display (LCD) or light emitting diode (LED) display, includes EDID. EDID is a data structure provided by a digital display to describe its capabilities to a video source such as a graphics card or set-top box, and enables a host to know what type of monitor is connected to it. EDID may include, in a 128-byte or 256-byte binary file format, manufacturer name and serial number, product type, phosphor or filter type, resolution, scanning frequency and timings supported by the display, display size, luminance data and pixel mapping data. The most current version is Enhanced EDID (E-EDID) Release A, v1.3.

The hosts H1-H4 may each include a computing device such as a personal computer (PC), laptop, notebook computer, personal digital assistant (PDA) or smartphone.

The electronic device 10 includes a processor 11, a memory 12 and a controller 14. The controller 14 includes control units 140-144 for transmitting the EDID of the display M1 through channels 150-154. These channels 150-154, in an embodiment according to the present invention, include “Inter-Integrated Circuit” (I2C) buses defined in the “Display Data Channel” (DDC) standard. Moreover, the control unit 140 serves as a master while the control units 141-144 serve as slaves in the transmission of the EDID. In some embodiments, the memory 12 includes a random access memory (RAM). Moreover, the electronic device 10 includes a field-programmable gate array (FPGA) chip, an application-specific integrated circuit (ASIC) device, or a system-on-chip (SOC) device.

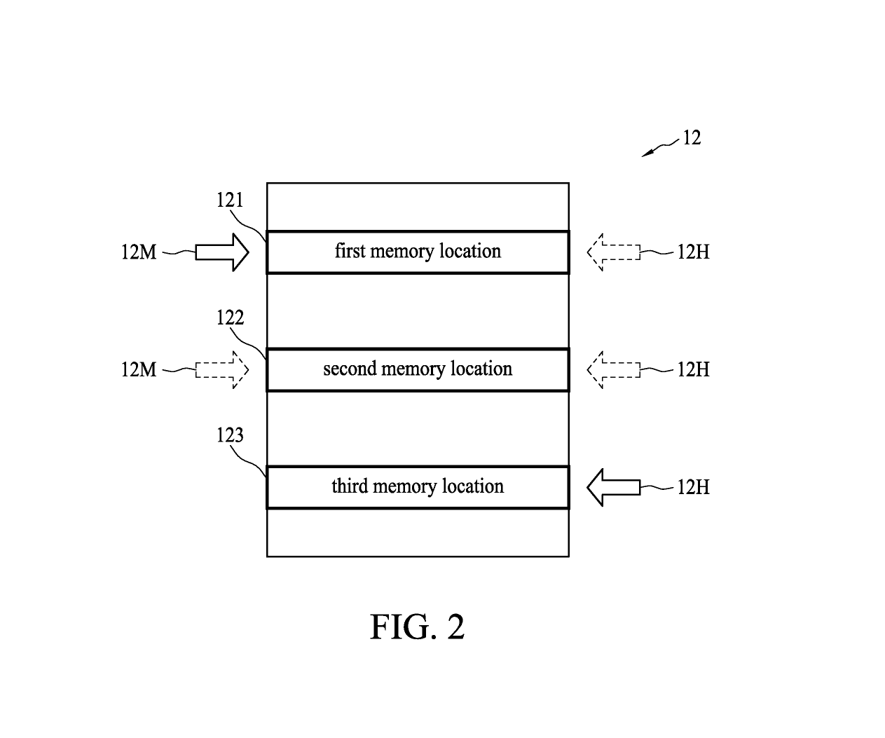

In operation, when the display M1 is electrically connected to the electronic device 10, under the control of the processor 11, the control unit 140 writes the EDID of the display M1 into the memory 12 in accordance with the DDC standard. Subsequently, under the control of the processor 11, each of the hosts H1-H4 can access the EDID of the display M1 through a corresponding one of the control units 141-144 in accordance with the DDC standard. Writing and reading the EDID will be further discussed in detail with reference to FIG. 2 below.

FIG. 2 is a schematic diagram showing a structure of the memory 12 in accordance with some embodiments of the present invention. Referring to FIG. 2, the memory 12 includes a first memory location 121, a second memory location 122 and a third memory location 123. The first memory location 121 and the second memory location 122 are configured to store data, for example, EDID in an alternate manner Moreover, the third memory location 123 is configured to store a default EDID to ensure that the hosts H1-H4 can read an EDID in case no EDID is stored in the first memory location 121 or the second memory location 122, or the EDID stored therein is invalid.

Also referring to FIG. 1, the processor 11 is configured to set a first pointer 12H indicative of one of the first, second and third memory locations 121, 122 and 123. The first pointer 12H points to a memory location where EDID is accessible to the hosts H1-H4. In the present embodiment as shown, the first pointer 12H points to the third memory location 123, which means that the hosts H1-H4 can read a default EDID stored in the third memory location 123.

Furthermore, the processor 11 is configured to set a second pointer 12M indicative of one of the first and second memory locations 121 and 122. The second pointer 12M points to a memory location to store the most recently written EDID. In the present embodiment as shown, the second pointer 12M points to the first memory location 121, which means that a display is currently connected to the electronic device 10 and the EDID of the display is to be written to the first memory location 121. In an embodiment, if the EDID of the currently connected display is correct, the first pointer 12H is then set to point to a memory location where the EDID of the currently connected display is stored. In the present embodiment, the first pointer 12H is set to point to the first memory location 121 so that the hosts H1-H4 can read the most updated EDID. If the EDID is not correct, the first pointer 12H is set to point to or is kept pointing to the third memory location 123.

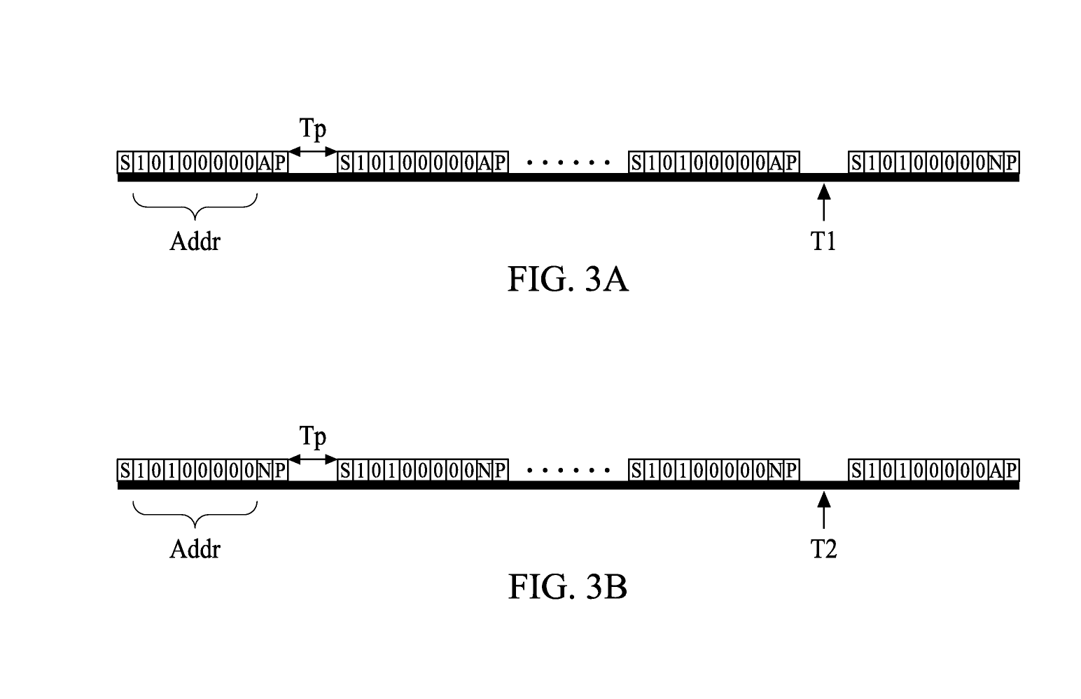

FIGS. 3A and 3B are schematic diagrams showing a method of detecting the connection status of a display in accordance with some embodiments of the present invention. To detect whether a display is connected to or disconnected from the electronic device 10, the first control unit 140 is configured to send an instruction, for example, Address 0xA0, in accordance with the DDC standard, towards the display M1 via the channel 150. The instruction is periodically sent at a regular interval Tp, for example, every two seconds when a polling procedure starts (denoted as “S” followed by the instruction). If a display is found connected, a signal “ACK” (denoted as “A”) is replied via the channel 150 to the first control unit 140. If a display if found disconnected or no display is connected, a signal “NAK” (denoted as “N”) is replied via the channel 150 to the first control unit 140. The polling procedure ends (denoted as “P”) after the status of connection, “ACK” or “NAK,” is replied.

Referring to FIG. 3A, initially a signal “ACK” is received, which means that a display is currently connected to or stays connected to the electronic device 10. Subsequently, in a polling procedure at time T1, a signal “NAK” is received, which means that the display is disconnected from the electronic device. The status of connection is changed from “plug” to “unplug.”

Referring to FIG. 3B, initially a signal “NAK” is received, which means that no display is connected or a display is currently disconnected. Subsequently, in a polling procedure at time T2, a signal “ACK” is received, which means that a display is connected to the electronic device. The status of connection is changed from “unplug” to “plug.”

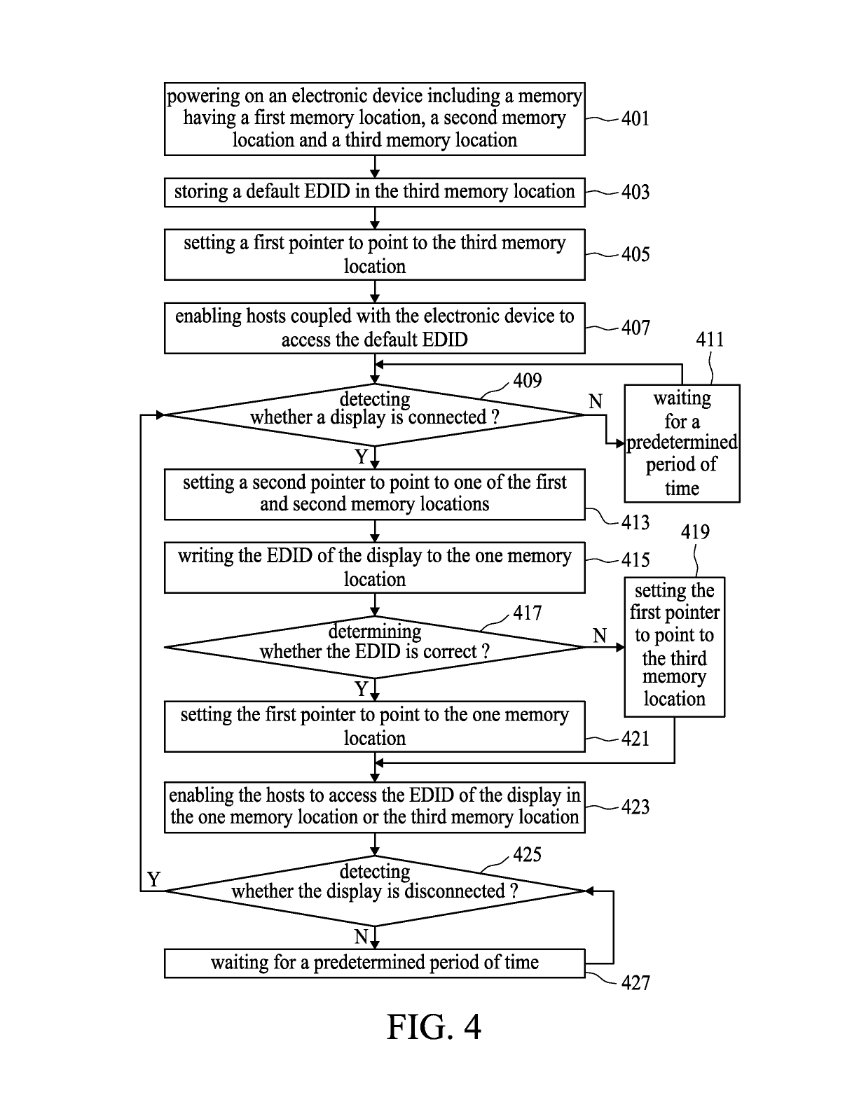

FIG. 4 is a flow diagram of a method of sharing the EDID of a display among multiple hosts in accordance with some embodiments of the present invention. Referring to FIG. 4, also referring to FIG. 1, in operation 401, an electronic device such as the electronic device 10 described and illustrated with reference to FIG. 1 is powered on. The electronic device includes a memory having a first memory location, a second memory location and a third memory location.

In operation 403, a default EDID is stored in the third memory location. The default EDID may include a general EDID, which is applicable to multiple hosts.

In operation 405, a first pointer is then set by, for example, a processor of the electronic device to point to the third memory location. As previously discussed, the first pointer indicates a memory location in the memory, where a stored default EDID is accessible to hosts coupled with the electronic device.

In operation 407, the hosts are allowed to read the default EDID in the third memory location as pointed to by the first pointer.

In operation 409, it is detected whether a display is connected to the electronic device. If not, in operation 411, the detection of connection status in operation 409 is performed after a predetermined period of time. Operations 409 and 411 are repeated until a display is found connected to the electronic device. Then in operation 413, a second pointer is set by the processor to point to one of the first memory location and the second memory location absent EDID or having a longer existed EDID. Since initially there is no EDID stored in the first or second memory location, for convenience, in the present embodiment it is assumed that the EDID is written to the first memory location. As previously discussed, the second pointer indicates a memory location in the memory, where EDID of the most recently connected display is to be stored.

In operation 415, the EDID of the connected display is written to one memory location, the first memory location. In some embodiments, EDIDs of displays connected to the electronic device at different time are alternately written to the first and second memory locations. For example, the EDID of a first display is written to the first memory location, while the EDID of a second display is subsequently written to the second memory location when the second display is connected after the first display is disconnected. In an embodiment, the first display and the second display may refer to a same display. In that case, the first display connected to the electronic device is first disconnected and then reconnected. In another embodiment, the first display and the second display are different displays and thus have different EDIDs. Moreover, when a third display is connected after the second display is disconnected, the first memory location where the EDID of the first display is stored can be overwritten with the EDID of the third display. Further, when a fourth display is connected after the third display is disconnected, the second memory location where the EDID of the second display is stored can be overwritten with EDID of the fourth display. Likewise, the third and fourth displays may refer to a same display or different displays, and each of the third and fourth displays may be the same first or second display.

In operation 417, it is determined whether the EDID of the connected display is correct by, for example, examining the checksum of the EDID. If not correct, in operation 419, the first pointer is set to point to the third memory location where the default EDID is stored. If correct, then in operation 421, the first pointer is set to point to the first memory location where the EDID of the currently connected display is stored.

Subsequent to operations 419 and 421, in operation 423, the hosts are allowed to read the EDID of the display in the first memory location or the default EDID in the third memory location.

In operation 425, it is detected whether the display is disconnected. If not, after a predetermined time in operation 427, detection of the connection status of the display in operation 425 is performed. Operations 425 and 427 are repeated until the display is disconnected. If the display (say, a first display) is disconnected, then in operation 409, it is detected whether a second display is connected. The second display may be a different display or the same first display just disconnected.

Next, in operation 413, if the second display is detected, the second pointer is set to point to the second memory location. Subsequently, in operation 415, the EDID of the second display is written to the second memory location. If the EDID of the second display is found correct in operation 417, the first pointer is then set to point to the second memory location in operation 421, so that the hosts can read the EDID of the second display in operation 423. If the EDID of the second display is found incorrect in operation 417, the first pointer is set to point to the third memory location in operation 419 and the hosts read the default EDID in operation 423.

Operations 409 to 427 are repeated to find if a third display is connected to the electronic device after the second display is disconnected. And, if so, since the EDID of the first display in the first memory location is stored longer than the EDID of the second display in the second memory location, the first memory location, which has a longer existed EDID, is overwritten using the EDID of the third display. Similarly, operations 409 to 427 are repeated to find if a fourth display is connected after the third display is disconnected. And, if affirmative, since the EDID of the second display in the second memory location is stored longer than the EDID of the third display in the first memory location, the second memory location, which now has a longer existed EDID, is overwritten using the EDID of the fourth display.

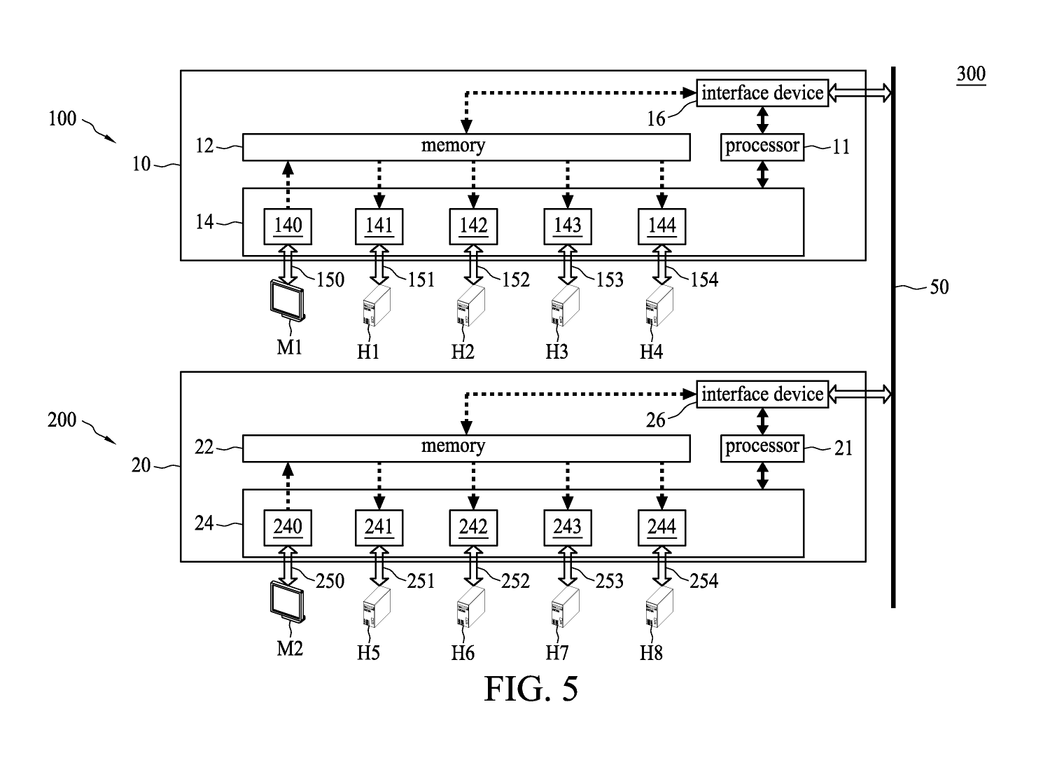

FIG. 5 is a block diagram of a system 300 in accordance with some embodiments of the present invention. Referring to FIG. 5, the system 300 includes a first system 100, a second system 200 and a communication interface 50. The second system 200 is similar in function and architecture to the first system 100 described and illustrated with reference to FIG. 1. In some embodiments, the second system 200 may be disposed remotely from the first system 100. Specifically, the first system 100 includes a first electronic device 10, a first display M1 and multiple first hosts H1-H4. The first electronic device 10 further includes a first processor 11, a first memory 12, a first controller 14 and a first interface device 16.

Similarly, the second system 200 includes a second electronic device 20, a second display M2 and multiple second hosts H5-H8. The second electronic device 20 further includes a second processor 21, a second memory 22, a second controller 24 and a second interface device 26. The second controller 24 includes first control unit 240 and second control units 241-244 for transmitting the EDID of the second display M2 through channels 250-254. These channels 250-254, in an embodiment according to the present invention, include I2C buses. Moreover, the first control unit 240 serves as a master while the second control units 241-244 serve as slaves in the transmission of the EDID.

The communication interface 50 facilitates the transmission of EDID between the first electronic device 10 in the first system 100 and the second electronic device 20 in the second system 200. In some embodiments, the communication interface 50 includes a serial peripheral interface (SPI), a universal asynchronous receiver/transmitter (UART), or other interfaces suitable for data transmission.

In operation, as previously discussed, the EDID of the first display M1 is written to the first memory location 121 of the first memory 12 and is subsequently accessible to the first hosts H1-H4. A user can thus control the first hosts H1-H4, using the first display M1. Moreover, the EDID of the second display M2 is written to a first memory location (not shown) of the second memory 22, and is subsequently accessible to the second hosts H5-H8. A user can thus control the second hosts H5-H8, using the second display M2. With the communication interface 50, in the first system 100, under the control of the first processor 11, the EDID of the first display M1 is retrieved from the first memory location 121 of the first memory 12, and then sent through the first interface device 16 over the communication interface 50 to the second electronic device 20. Meanwhile, in the second system 200, under the control of the second processor 21, the EDID of the first display M1 sent over the communication interface 50 is received through the second interface device 26 and then stored in a second memory location (not shown) of the second memory 22. The EDID of the first display M1 is subsequently accessible to the second hosts H5-H8. Accordingly, a user can control the second hosts H5-H8 in the second system 200 by means of the first display M1 in the first system 100, or control the second hosts H5-H8 by means of the second display M2 in the second system 200.

Similarly, in the second system 200, under the control of the second processor 21, the EDID of the second display M2 is retrieved from the first memory location of the second memory 22, and then sent through the second interface device 26 over the communication interface 50 to the first electronic device 10. Meanwhile, in the first system 100, under the control of the first processor 11, the EDID of the second display M2 sent over the communication interface 50 is received through the first interface device 16 and then stored in the second memory location 122 of the first memory 12. The EDID of the second display M2 is subsequently accessible to the first hosts H1-H4. Accordingly, a user can control the first hosts H1-H4 by means of the first display M1 in the first system 100, or control the first hosts H1-H4 in the first system 100 by means of the second display M2 in the second system 200.

As previously discussed, each of the first memory 12 and the second memory 22 may include a third memory location to store a default EDID. Moreover, the first and second memory locations of each of the first memory 12 and the second memory 22 may be overwritten with the EDID of the most recently connected display, either detected by the first control unit 140 of the first controller 14 in the first system 100, or by the first control unit 240 of the second controller 24 in the second system 200. Although only two systems 100 and 200 are shown, three or more such systems working in conjunction with the communication interface 50 fall within the contemplated scope of the present disclosure.

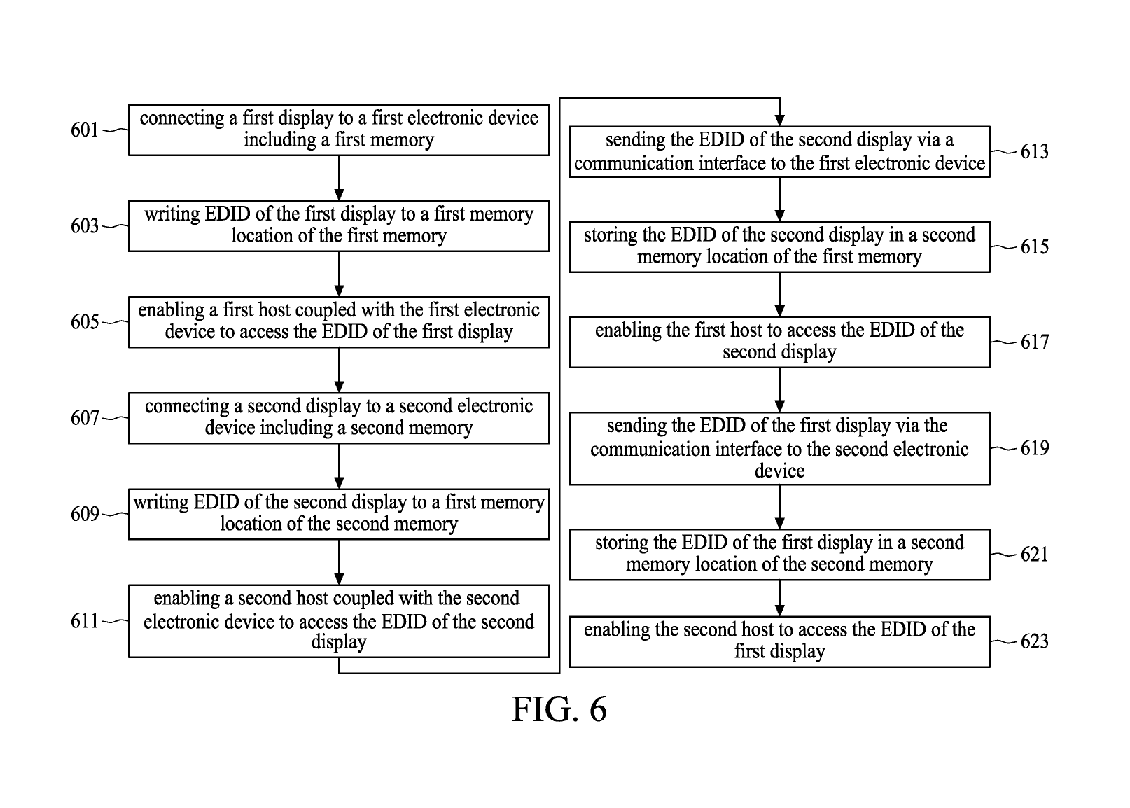

FIG. 6 is a flow diagram of a method of sharing EDIDs of displays among multiple hosts in accordance with some embodiments of the present invention. Referring to FIG. 6, also referring to FIG. 5, in operation 601, a first display is connected to a first electronic device in a first system. The first electronic device includes a first memory.

EDID of the first display is written to a first memory location of the first memory in operation 603. As a result, a first host connected to the first electronic device can access the EDID of the first display in operation 605.

Likewise, in operation 607, a second display is connected to a second electronic device in a second system, which may be remote to the first system. The second electronic device includes a second memory. EDID of the second display is written to a first memory location of the second memory in operation 609. As a result, a second host connected to the second electronic device can access the EDID of the second display in operation 611. In some embodiments, operations 607 to 611 may be performed prior to operations 601 to 605.

In operation 613, the EDID of the second display in the second system is sent via a communication interface to the first electronic device in the first system. The EDID of the second display is written to a second memory location of the first memory in operation 615, and then the first host can access the EDID of the second display in operation 617. Accordingly, a user is allowed to control the first host by means of the first display in the first system, or control the first host by means of the second display in the second system.

Likewise, in operation 619, the EDID of the first display in the first system is sent via the communication interface to the second electronic device in the second system. The EDID of the first display is written to a second memory location of the second memory in operation 621, and then the second host can access the EDID of the first display in operation 623. Accordingly, a user is allowed to control the second host by means of the second display in the second system, or control the second host in the second system by means of the first display in the first system. In some embodiments, operations 619 to 623 may be performed prior to operations 613 to 617.

Embodiments according to the present disclosure provide an electronic device that comprises a memory and a controller. The memory includes a first memory location and a second memory location, which are configured to store data in an alternate manner The controller is configured to write, when connection of a display to the electronic device is detected, extended display identification data (EDID) of the display through a first channel to one of the first and second memory locations, and to enable the EDID of the display to be accessible to hosts through second channels.

In an embodiment, the controller includes a first control unit and is configured to write, when connection of a first display to the electronic device is detected, EDID of the first display to the first memory location through the first control unit.

In another embodiment, the controller is configured to write, when connection of a second display to the electronic device is detected, EDID of the second display to the second memory location through the first control unit.

In still another embodiment, the controller is configured to overwrite, when connection of a third display to the electronic device is detected, the first memory location through the first control unit, using EDID of the third display.

In yet another embodiment, the controller includes second control units each corresponding to one of the hosts.

In yet still another embodiment, the controller is configured to overwrite one of the first and second memory locations that has a longer existed EDID.

In an embodiment, the memory further includes a third memory location to store a default EDID.

In another embodiment, the electronic device further comprises a processor, which is configured to set a first pointer to point to one of the first, second and third memory locations for the hosts to access.

In still another embodiment, the processor is configured to set a second pointer to point to one of the first and second memory locations to store the most recently written EDID.

Some embodiments according to the present disclosure provide an electronic device that comprises a memory, a first control unit, second control units and a processor. The memory includes a first memory location and a second memory location, which are configured to store data in an alternate manner The first control unit is configured to write extended display identification data (EDID) of a display to one of the first and second memory locations when connection of the display to the electronic device is detected. Each of the second control units corresponds to one of multiple hosts, and is configured to allow the corresponding one host to read the EDID of the display connected to the electronic device. The processor is configured to set a first pointer to point to one of the first and second memory locations where the most recently written EDID is stored.

In an embodiment, the first control unit is configured to overwrite one of the first and second memory locations that has a longer existed EDID.

In another embodiment, the memory further includes a third memory location to store a default EDID.

In still another embodiment, the processor is configured to set the first pointer to point to one of the first, second and third memory locations for the hosts to access.

In yet another embodiment, the processor is configured to set a second pointer to point to one of the first and second memory locations to store the most recently written EDID.

In yet still another embodiment, the electronic device further comprises an interface device, which is configured to receive EDID of a display from another electronic device.

Embodiments according to the present disclosure also provide a system that comprises a first electronic device, a second electronic device and a communication interface. The first electronic device includes a first memory, and a first controller including a first control unit to write EDID of a first display to a first memory location of the first memory, and a second control unit to allow a first host to read the EDID of the first display. The second electronic device includes a second memory, and allows a second controller including a first control unit to write EDID of a second display to a first memory location of the second memory, and a second control unit to allow a second host to read the EDID of the second display. The communication interface between the first and second electronic devices is configured to allow the first electronic device to send the EDID of the first display to the second electronic device, and allow the second electronic device to send the EDID of the second display to the first electronic device.

In an embodiment, the first electronic device includes a first processor configured to retrieve the EDID of the first display from the first memory location of the first memory, and send the EDID of the first display via the communication interface to the second electronic device.

In another embodiment, the second electronic device includes a second processor configured to receive the EDID of the first display and store the EDID of the first display in a second memory location of the second memory.

In still another embodiment, the second electronic device includes a second processor configured to retrieve the EDID of the second display from the first memory location of the second memory, and send the

EDID of the second display via the communication interface to the first electronic device.

In yet another embodiment, the first electronic device includes a first processor configured to receive the EDID of the second display and store the EDID of the second display in a second memory location of the first memory.

Although the present invention and its advantages have been described in detail, it should be understood that various changes, substitutions and alterations can be made herein without departing from the spirit and scope of the invention as defined by the appended claims. For example, many of the operations discussed above can be implemented in different methodologies and replaced by other operations, or a combination thereof.

Moreover, the scope of the present application is not intended to be limited to the particular embodiments of the process, machine, methods and steps described in the specification. As one of ordinary skill in the art will readily appreciate from the disclosure of the present invention, processes, machines, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, methods, or steps.

What is claimed is:

1. An electronic device, comprising:
a memory including a first memory location and a second memory location, which are configured to store data in an alternate manner; and
a controller configured to write, when connection of a display to the electronic device is detected, extended display identification data (EDID) of the display through a first channel to one of the first and second memory locations, and to enable the EDID of the display to be accessible to hosts through second channels.

2. The electronic device of claim 1, wherein the controller includes a first control unit and is configured to write, when connection of a first display to the electronic device is detected, EDID of the first display to the first memory location through the first control unit.

3. The electronic device of claim 2, wherein the controller is configured to write, when connection of a second display to the electronic device is detected, EDID of the second display to the second memory location through the first control unit.

4. The electronic device of claim 3, wherein the controller is configured to overwrite, when connection of a third display to the electronic device is detected, the first memory location through the first control unit, using EDID of the third display.

5. The electronic device of claim 2, wherein the controller includes second control units each corresponding to one of the hosts.

6. The electronic device of claim 1, wherein the controller is configured to overwrite one of the first and second memory locations that has a longer existed EDID.

7. The electronic device of claim 1, wherein the memory further includes a third memory location to store a default EDID.

8. The electronic device of claim 7 further comprising a processor, the processor configured to set a first pointer to point to one of the first, second and third memory locations for the hosts to access.

9. The electronic device of claim 8, wherein the processor is configured to set a second pointer to point to one of the first and second memory locations to store the most recently written EDID.

10. An electronic device, comprising:
a memory including a first memory location and a second memory location, which are configured to store data in an alternate manner;
a first control unit to write extended display identification data (EDID) of a display to one of the first and second memory locations when connection of the display to the electronic device is detected;
second control units each corresponding to one of multiple hosts, and being configured to allow the corresponding one host to read the EDID of the display connected to the electronic device; and
a processor to set a first pointer to point to one of the first and second memory locations where the most recently written EDID is stored.

11. The electronic device of claim 10, wherein the first control unit is configured to overwrite one of the first and second memory locations that has a longer existed EDID.

12. The electronic device of claim 10, wherein the memory further includes a third memory location to store a default EDID.

13. The electronic device of claim 10, wherein the processor is configured to set the first pointer to point to one of the first, second and third memory locations for the hosts to access.

14. The electronic device of claim 10, wherein the processor is configured to set a second pointer to point to one of the first and second memory locations to store the most recently written EDID.

15. The electronic device of claim 10 further comprising an interface device configured to receive EDID of a display from another electronic device.

16. A system, comprising:
a first electronic device including:
a first memory; and
a first controller including a first control unit to write EDID of a first display to a first memory location of the first memory, and a second control unit to allow a first host to read the EDID of the first display;
a second electronic device including:
a second memory; and
a second controller including a first control unit to write EDID of a second display to a first memory location of the second memory, and a second control unit to allow a second host to read the EDID of the second display; and
a communication interface between the first and second electronic devices to allow the first electronic device to send the EDID of the first display to the second electronic device, and allow the second electronic device to send the EDID of the second display to the first electronic device.

17. The system of claim 16, wherein the first electronic device includes a first processor configured to retrieve the EDID of the first display from the first memory location of the first memory, and send the EDID of the first display via the communication interface to the second electronic device.

18. The system of claim 17, wherein the second electronic device includes a second processor configured to receive the EDID of the first display and store the EDID of the first display in a second memory location of the second memory.

19. The system of claim 16, wherein the second electronic device includes a second processor configured to retrieve the EDID of the second display from the first memory location of the second memory, and send the EDID of the second display via the communication interface to the first electronic device.

20. The system of claim 19, wherein the first electronic device includes a first processor configured to receive the EDID of the second display and store the EDID of the second display in a second memory location of the first memory.
